(19) United States
(12) Patent Application Publication
(10) Pub. No.: US 2014/0012777 A1
(43) Pub. Date: Jan. 9, 2014

(54) SYSTEM AND METHOD FOR VOLATILITY-BASED CHARACTERIZATION OF SECURITIES

(71) Applicant: John D. Freeman, Solana Beach, CA (US)

(72) Inventor: John D. Freeman, Solana Beach, CA (US)

(21) Appl. No.: 13/749,555

(22) Filed: Jan. 24, 2013

Related U.S. Application Data
(63) Continuation-in-part of application No. 13/365,209, filed on Feb. 2, 2012.
(60) Provisional application No. 61/590,304, filed on Jan. 24, 2012.
(60) Provisional application No. 61/590,304, filed on Jan. 24, 2012.

(51) Int. Cl. G06Q 40/06

(52) U.S. Cl. CPC G06Q 40/06
USPC 705/36 R

(57) ABSTRACT

A volatility-based securities index framework solves problems with the prior art. By recognizing that investors share the rational goal of earning the highest level of return for any level or risk, a volatility-based index provides investors with information about the most distinct choices in risk. Compared to known approaches, a volatility-based index framework partitions a securities market into much more differentiated segments which in turn provide much more distinct investment choices. Further, within each volatility segment, constituent members are more homogeneous facilitating a clearer understanding of each group's relative attractiveness. At an asset allocation level, improved risk choices expand opportunities to convert poorly compensated high risk investments into more attractive investments elsewhere. The persistence of volatility maintains style distinctions effectively over time, offering significant protection to tax exposed investors.

### REFERENCE TO RELATED APPLICATION

The present application claims priority to U.S. patent application Ser. No. 13/365,209, filed 2 Feb. 2012 and to U.S. Provisional Patent Application No. 61/590,304, filed 24 Jan. 2012 and titled “System and Method of Volatility-Based Characterization of Securities.” The entire disclosure of each above application is hereby incorporated by reference and made part of this specification.

### BACKGROUND

1. Field

The present invention relates generally to systems and methods for constructing and applying financial indexes.

2. Description of Related Art

Early securities indexes were designed to provide general insights into broad market behaviors. These indexes, however, proved problematic in judging the performance of most active investment managers, who invest selectively based on various information including technical and fundamental analysis. Financial analysts in response developed specialized securities indexes—sometimes called style indexes—meant to reflect the ‘broad brush’ investments style underlying many active strategies. One category of such indexes represented splits between value and growth, and between large and small securities. Such value-growth based indexes proved useful in approximating many active equity strategies.

### SUMMARY

The present invention solves problems with prior art financial indexes by providing a volatility-based securities index framework. By recognizing that investors share the rational goal of earning the highest level of return for any level or risk, a volatility-based index provides investors with information about the most distinct choices in risk.

Compared to known approaches, a volatility-based index framework partitions a securities market into much more differentiated segments which in turn provide much more distinct investment choices. Further, within each volatility segment, constituent members are more homogeneous facilitating a clearer understanding of each group's relative attractiveness. At an asset allocation level, improved risk choices expand opportunities to convert poorly compensated high risk investments into more attractive investments elsewhere. Additionally, the persistence of volatility maintains style distinctions effectively over time, offering significant protection to tax exposed investors.

A volatility-based index framework allows investors to build asset mixes which are less convex, relying not on a combination of unrealistically high expected returns from speculative equities in combination with high levels of safety from long-dated government debt. For example, this novel framework allows for asset mixes favoring stock-like bonds and bond-like stocks which could produce very attractive risk-adjusted returns, particularly with rising interest rates. Should an investor forecast commensurately high returns for high risk investments, however, the volatility-based index framework allows for even more convex solutions than would be possible under conventional style indexes.

### BRIEF DESCRIPTION OF THE DRAWINGS

FIG. 1 illustrates a schematic diagram of examples of system and computer-readable medium embodiments provided in accordance with the present invention.

FIG. 2 illustrates an embodiment of a process for generating volatility style indices using a volatility-based index framework.

FIG. 3 shows a representation of volatility style indices in a volatility-based index framework.

FIG. 4 shows a chart of historical cumulative returns over time for a volatility-based index framework comprising four volatility style indices.

FIG. 5 shows a table illustrating the advantages of a volatility-based index framework.

FIG. 6 shows a chart illustrating the persistence of volatility.

FIG. 7 shows an example of a portfolio constructed from conventional asset classes.

FIG. 8 shows an example of a portfolio constructed using volatility style indices in place of traditional value-growth indexes.

FIG. 9 shows another example of a portfolio constructed using volatility style indices.

FIG. 10 shows performance results of two portfolios constructed using volatility style indices compared to performance results of two conventional portfolios.

FIG. 11 illustrates an example of style analysis using traditional value-growth indexes.

FIG. 12 illustrates an example of style analysis using volatility style indices.

FIG. 13 illustrates an example of a process for benchmarking investment fund or investment managers using an index framework.

FIG. 14 illustrates an embodiment of a process for benchmarking investment fund or investment managers using a volatility-based index framework.

FIG. 15 shows a chart of price/earnings ratios for a volatility-based index framework comprising four volatility style indices.

FIG. 16 shows a chart of price/forecast earnings ratios for a volatility-based index framework comprising four volatility style indices.

FIG. 17 shows a chart of price/book ratios for a volatility-based index framework comprising four volatility style indices.

FIG. 18 shows a chart of dividend yields for a volatility-based index framework comprising four volatility style indices.

FIG. 19 shows a chart of price/sales ratios for a volatility-based index framework comprising four volatility style indices.

FIG. 20 shows a chart of return on equity for a volatility-based index framework comprising four volatility style indices.

### DETAILED DESCRIPTION

Modern financial indexes, such as value/growth indexes, are designed to reflect the behavior of active managers. The success of these indexes is gauged to a large degree by their ability to capture these behaviors. And while the modern financial indexes may be successful in this regard, they fail to prove effective for other purposes. Further, as investors increasingly gravitate toward total return investments (hedge funds, etc.) style indexes that simply mirror the broader market volatility become increasingly irrelevant to the problems of asset allocation and performance attribution.

Modern portfolio theory suggests constructing an optimal asset portfolio by using risk and return data to determine the proportions of various types of portfolio assets. Portfolio theory thus works best when asset-type choices are distinct—when available asset classes or groups are as different as possible. The construction of an optimally efficient portfolio depends on this differentiation. Modern financial indexes, designed to reflect investment strategies of active managers, fail to accommodate this goal.

Value and growth indexes, for example, overlap significantly in various important characteristics: that which makes these indexes characteristically similar to the managers makes them characteristically similar to each other. This high degree of overlap among known financial indexes provides inadequate differentiation and distinct choices in selecting assets for an optimally efficient portfolio.

### Differentiation in Style Index Volatility as an Explicit Objective

Desirable investment portfolios tend to focus in a securities market around the moderate middle of the growth-value continuum; investors can then make opportunistic forays to the extremes (e.g., greater growth or fundamental cheapness). This indicates that both value and growth indexes are populated—at least at their extremes—with risky investments. This risk overlap confounds the risk-return tradeoffs on which modern portfolio theory depends. An index framework which addresses varying risk characteristics is thus required.

The present invention meets this requirement and solves problems with known financial indexes by providing a volatility-based index framework. Recognizing that investors share the goal of earning the highest level of return for any level of risk, a volatility-based index framework provides investors with valuable information about, among other things, the most distinct choices in risk. Distinct choices both broaden and strengthen investors' opportunity set.

Volatility style indices also provide a surprising and effective new way to categorize and evaluate securities for various purposes including determining asset classes, market benchmarking, portfolio analysis, and evaluating fund performance. ‘Security’ is a broad term extending across a broad reach of investable asset classes and their constituent securities; the term is to be given its ordinary and customary meaning to a person of ordinary skill in the art (i.e., it is not to be limited to a special or customized meaning) and includes, without limitation, equity (common stock, preferred, convertible issues), debt (bonds, banknotes, debentures), real estate, currency investments, so-called alternate assets such as natural resources, precious metals, commodities, venture capital, hedge funds, and investable strategies.

Focusing on volatility does not forfeit insights provided by other fundamental measures; it amplifies them, rather, thus allowing more effective choices in the search for superior risk-adjusted returns (e.g., as measured by alpha). Investors can use the volatility style indices to gain insights into the risk-return opportunities among various investments. The volatility style indices can be structured to span the broad market, thus allowing plug-and-play compatibility with the capital asset pricing model (CAPM) and other aspects of modern portfolio theory. Further, the volatility fracture provided by a volatility-based index framework facilitates tradeoffs between equity risk and other asset classes.

As discussed later, a volatility-based index framework demonstrably provides greater differentiation in choices for security exposure, not only with regard to risk, but also with regard to other equally important indicators such as cumulative or average return and Sharpe ratio. Further still, volatility style indices are demonstrably persistent, with a low turnover among the indices, which facilitates predictability.

### System Design

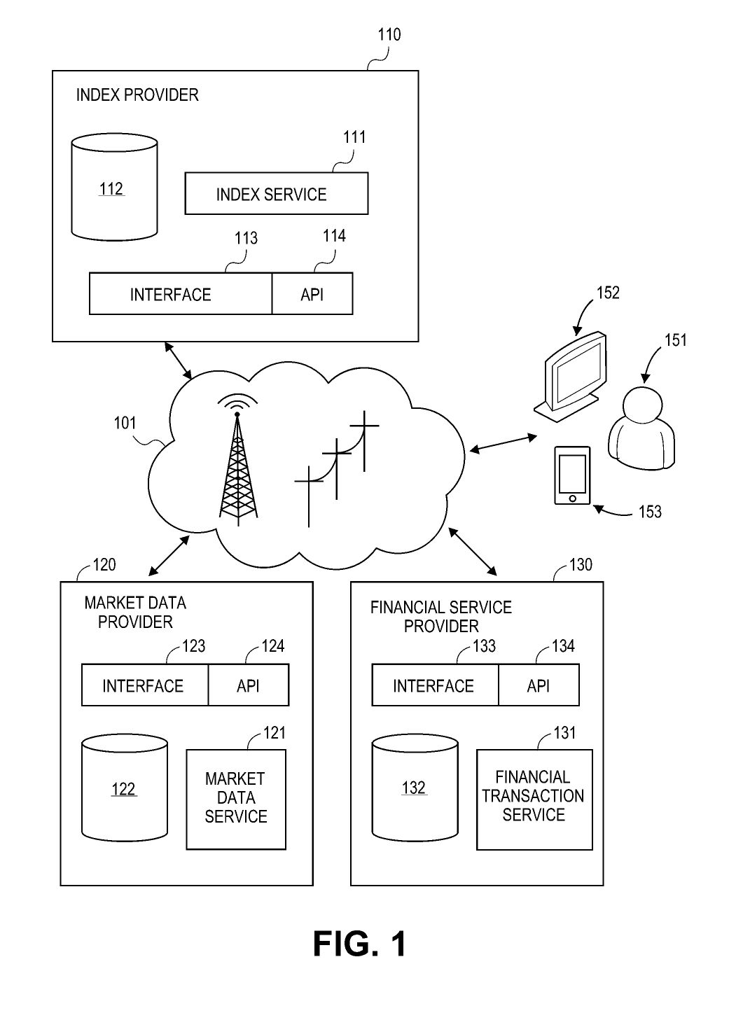

FIG. 1 illustrates a schematic diagram of examples of system and computer-readable medium embodiments provided in accordance with the present invention.

An index provider 110, market data provider 120, financial service provider 130, and investor 151 can communicate over a network. The network can include, for example and without limitation, wires or wireless data networks (e.g., networks utilizing T1, E1, T2, E2, T3, E3, DS4, E4, DS1, DS2, DS3, 1 MB Ethernet, 10 MB Ethernet, 100 MB Ethernet, 1 GB Ethernet, 10 GB Ethernet, Backplane Ethernet, resilient packet ring, Frame Relay, VDSL, ADSL, DSL, FCS, FDDI, Firewire, SCSI, Fiberchannel, FICON, ESCON, STS-1, OC-1, OC-3, OC-12, 25 OC-48, OC-192, OC-768, ATM UNI, ATM NNI, WiFi, WiMAX, ATM, or the like), connections through a networked medium or media (e.g., the Internet, an extranet, an intranet, a wide area network (WAN), a local area network (LAN), or the like), and various devices (e.g., hubs, routers, switches, relays, VPN servers, firewalls, intrusion detection systems, NAT devices, aggregators, or the like). Network 101 can also include, for example, various combinations of these and other systems and communications technologies. In various embodiments, the network 101 supports secure communications, for example, using various security techniques (operating, e.g., at various network layers), including but not limited to Secure Sockets Layer (SSL), Layer 2 Tunneling Protocol (L2TP), Transport Layer Security (TLS), Tunneling TLS (TTLS), IPSec, HTTP Secure (HTTPS), Extensible Authentication Protocol, (EAP), and the like.

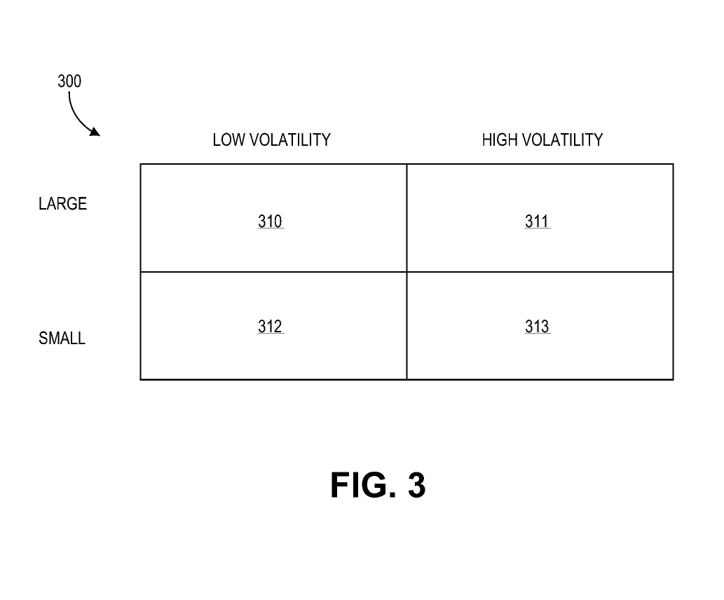

As shown in FIG. 3, an index provider 110 is associated with an interface module 113, an index service module 111, and a data store 112. The index service 111 can generate volatility style indices, for example, using data stored in data store 112 or obtained from the network (e.g., from market data provider 120). The index service can also provide on request current and historical data for volatility style indices. The data store 112 can store current and historical securities data, generated index information, user data, and any other data needed by the index provider. An interface 113 can provide access to services provided by the index service. For example, the financial service provider 130 or investor 151 can request updated index information from the index provider through the interface 113. If a volatility style index is manages as a mutual fund, exchange-traded fund, or the like, the interface can provide real-time fund data, order processing, and any related functionality. The interface can have an API component 114 for programmatic interaction with the index provider. In various embodiments, the API component can allow hardware or software devices connected to the network to obtain automatically index information and other data provided by the index provider 110.

A market data provider 120 is associated with an interface module 123, a market data service module 121, and a data store 122. The market data service 121 can provide current and historical market data (e.g., fundamental or technical indicators, news releases, real-time trade data, and other market data). The data store 122 can store current and historical market data, and any other information required by the market data provider 120 or other entities on the network. An interface 123 can provide access to services provided by the market data provider 120. For example, the index service provider 110, financial service provider 130, or investor 151 can request updated market information from the market data provider 120 through the interface 123. In various embodiments, detailed analyses or comparisons can be requested via the interface and processed by the market data service 121. The interface can have an API component for programmatic interaction with the market data provider. The interface can have an API component 124 for programmatic interaction with the market data provider. In various embodiments, the API component can allow hardware or software devices connected to the network to obtain automatically market data and other information provided by the market data provider 120.

A financial service provider 130 is associated with an interface module 133, a financial transaction service module 131, and a data store 122. The financial transaction service 131 can process securities transactions and complete other market operations for other entities such as and index provider 110 or investor 151. The data store 132 can store securities information, account information, trade information, or any other data needed by the financial service provider 130. An interface 133 can provide access to services provided by the financial service provider 130. For example, the index service provider 110, market data provider 120, or investor 151 can carry out securities transactions, check trade status, review account information, transfer assets, or the like through the interface 133. The interface 133 can have an API component 134 for programmatic interaction with the financial service provider. In various embodiments, the API component 134 can allow hardware or software devices connected to the network 101 to initiate automatically market transactions or utilize other services provided by the financial service provider 120.

In various aspects, the investor 151 can be operatively associated with one or more computer systems 152 or devices 153. These systems and devices can include, for example and without limitation, a cell phone, smart phone, tablet computer, laptop, netbook, desktop computer, personal entertainment device, electronic book reader, other wireless device, set-top or other television box, media player, game platform, kiosk, or any other electronic device with appropriate interface and communication facilities.

It is to be understood that the figures and descriptions of embodiments of the present invention have been simplified to illustrate elements that are relevant for a clear understanding of the present invention, while eliminating, for purposes of clarity, other elements. Those of ordinary skill in the art will recognize, however, that these and other elements may be desirable for practice of various aspects of the present embodiments. Because such elements are well known in the art, and because they do not facilitate a better understanding of the present invention, a discussion of such elements is not provided herein. It can be appreciated that, in some embodiments of the present methods and systems disclosed herein, a single component can be replaced by multiple components, and multiple components replaced by a single component, to perform a given function or functions. Except where such substitution would not be operative to practice the present methods and systems, such substitution is within the scope of the present invention. Examples presented herein, including operational examples, are intended to illustrate potential implementations of the present method and system embodiments. It can be appreciated that such examples are intended primarily for purposes of illustration. No particular aspect or aspects of the example method, product, computer readable media, and/or system embodiments described herein are intended to limit the scope of the present invention.

It should be appreciated that figures presented herein are intended for illustrative purposes and are not intended as construction drawings. Omitted details and modifications or alternative embodiments are within the purview of persons of ordinary skill in the art. Furthermore, whereas particular embodiments of the invention have been described herein for the purpose of illustrating the invention and not for the purpose of limiting the same, it will be appreciated by those of ordinary skill in the art that numerous variations of the details, materials and arrangement of parts/elements/steps/functions may be made within the principle and scope of the invention without departing from the invention as described in the appended claims.

### Volatility-Based Index Construction

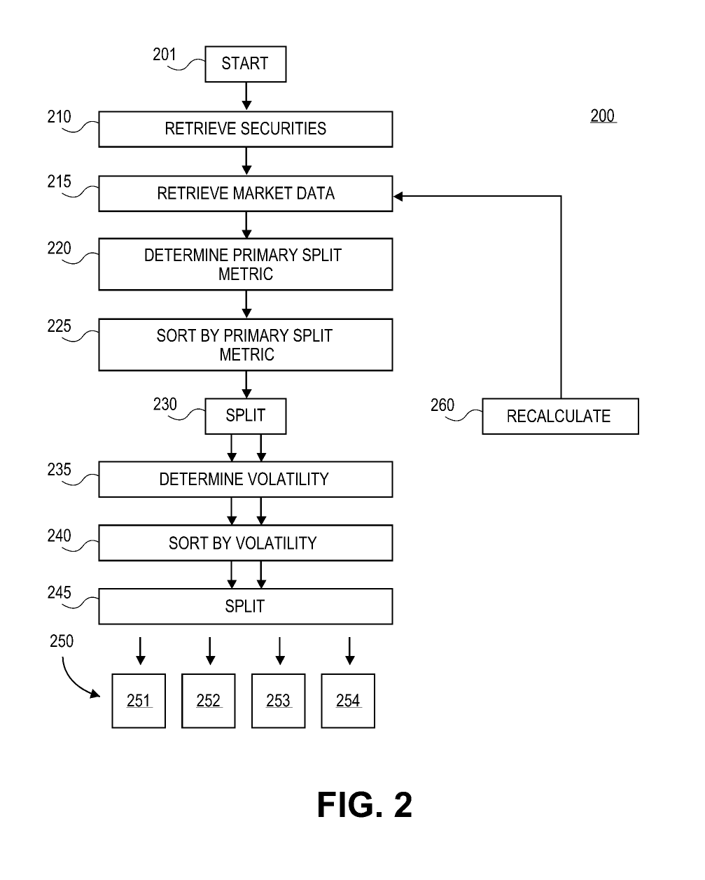

FIG. 2 illustrates an example of a process for generating volatility style indices using a volatility-based index framework. It should be noted that the process of FIG. 2 is only an example of an embodiment, and that alternative embodiments can be provided as discussed herein.

The process starts at step 201. At step 210, a collection of securities is received. For example the collection of securities can be retrieved by the index service 111 from the index provider data store 112 or from the market data provider 120. These securities can represent the entire market or a subset thereof. The securities in the collection can be selected based on any desired characteristic such as security type, industry type, country, or size (e.g., as measured by market capitalization). In various embodiments, the securities are selected, for example by index service 111, to represent most or all of the tradable securities market, or most or all of the tradable securities in a particular asset class. In such embodiments, the volatility style indices generated using the volatility-based index framework will collectively represent the entire market, or at least the entire market for a particular asset class. In various other embodiments, the selected securities need not represent the entire market. The securities collection can be stored in volatile or persistent memory, for example, of the index service 111. The security collection can be stored along with any other available data (e.g., current and historical performance information, correlation data, and the like).

At step 215, market data and other parameters for the securities in the collection is received. For example, index service 111 can retrieve detailed information regarding the securities collection from market data provider 120. This market data can include, for example, information about current and historical pricing data, outstanding shares, dividends, leverage, yield, trading activity, earnings, yield, growth, value, momentum, the like, and combinations of the same. The market data can be stored in association with the stored securities data, for example in the index provider's data store 112 or in memory associated with the index service 111. Further processing can also be performed on the received data. For example, the index service 111 can determine correlations among securities or derive other performance-related metrics. Results can be stored, for example, in the index provider data store 112.

At step 220, one or more primary split metrics are determined. In various embodiments, the primary split metrics can be determined by the index provider 111. The primary metrics can be any sortable data associated with each security. In various embodiments, the primary metrics can include default probability or maturity for a bond index or country of origin or a stock's market capitalization. In other embodiments, a primary metric can be float (market capitalization minus closely held shares). Using standard terminology, securities with a higher relative market capitalization or float are referred to as large or high-cap stocks; securities with lower relative market capitalization or float are referred to as small or low-cap stocks. At step 225, the securities are sorted by the selected primary metrics. For example, the securities in the collection can be sorted by the index service 111 according to market capitalization or float.

At step 230, the sorted securities collection is split into two or more groups of securities. Group membership is preferably mutually exclusive, but in various embodiments it can be overlapping. Together, the groups can contain all or a substantial portion of the securities in the collection. For example, the sorted collection of securities can be split into two groups, one containing securities with higher relative market capitalization and one with securities containing lower relative market capitalization. The two groups can be equally sized or one can be larger than the other. In some embodiments, the first group contains the 1000 securities with the highest market capitalization and the second segment contains the 2000 securities with the next highest market capitalization, excluding the 1000 securities included in the first group. In other embodiments, the groups can be allocated such that the groups have a determined relationship along a fundamental or technical indicator such as country or region of origin, or total market capitalization of member securities. This division of the collection of securities into two or more groups can represent a first dimension on which the securities collection is divided. Where the securities collection is divided into two groups based on float or market capitalization, the two groups can represent a divide between large and small securities.

It should be noted that division along one or more primary split metrics is optional. In various embodiments, index construction can be carried out by classifying securities according to volatility alone, or by dividing along various other metrics only after volatility classification. Further, dividing a collection of securities along one or more primary split metrics is a flexible process that can have multiple steps. For example, dividing along one or more split metrics can be repetitive, iterative, or sequential. In various embodiments, securities can first be divided based on asset type, further divided based on country of origin, and divided again based on market capitalization. This iterative process, which results in three hierarchical levels of division, is an example of dividing a securities collection along one or more primary metrics.

At step 235, volatility data is determined for the securities in each group. For example, historical price, volume, or other fundamental or technical indices can be obtained from data store 112 or from market data provider 120 by the index service 111 and used to obtain a volatility measure for each security. In various embodiments, the standard deviation of a securities price over an interval of time is used as a measure of volatility. For example, a volatility measure can be a long term volatility measure calculated by determining the standard deviation of a security's price over a historical period of 60 months. The resolution of the pricing data can depend on, among other things, the historical period over which the volatility measure is calculated. For example, where 60-month long term volatility is used, the volatility measure can be calculated using daily, monthly, or weekly price data. It should be noted that various other measures of volatility can be used.

At step 240, the securities in each group are sorted according to their determined or calculated volatilities. For example, where the collection of securities is divided into two groups representing small and large securities, the securities in each group can be sorted according to their relative volatilities.

At step 245, each group can be further divided into two or more sub-groups 250 based on volatility. Sub-group membership is preferably mutually exclusive, but in various embodiments it can be overlapping. Together, the sub-groups can contain all or a substantial portion of the securities in the corresponding group. For example, the securities in each group can be divided into two sub-groups: a high volatility subgroup comprising the most volatile securities in the group, and a low volatility subgroup comprising the remaining lower volatility securities. It is important to note that each group can be divided into any number of sub-groups. For example, a group can be divided into low, medium, and high volatility sub-groups. In some embodiments, each subgroup can comprise approximately the same number of securities. For example, where a group representing large securities is divided into low and high volatility subgroups, each subgroup can contain exactly or approximately half of the securities in the group of large securities. In other embodiments, the two or more sub-groups can have different numbers of constituents. For example, in various embodiments, the sub-groups can be allocated such that the subgroups have a determined relationship along a fundamental or technical indicator such as total market capitalization of member securities. Each of the sub-groups 250 created by dividing the groups can represent a distinct volatility style index in the volatility-based index framework. Data corresponding to the generated volatility style indices can be stored, for example, in index provider data store 112 and requested over the network 101 from the index provider 110.

FIG. 3 shows a representation of volatility style indices 300 in a volatility-based index framework. When the construction of the one or more subgroups 250 is complete, each subgroup represents a distinct index in the volatility-based index framework. For example, where a securities collection is divided into two groups based on float or market capitalization and each of these groups is divided into two subgroups based on long term volatility, the index framework produces four distinct indices: large low volatility 310, large high volatility 311, small low volatility 312, and small high volatility 313. Price, volume, and any other fundamental or technical data can be tracked independently for each index.

The above describes only a few examples of generating volatility-based frameworks. In various other embodiments, for example, a volatility-based framework can be constructed without dividing a securities collection by a primary metric. In such cases, the securities collection can be grouped and divided by volatility alone, or by volatility first followed by other dimensions. It should also be understood that all grouping and division into subgroups, at all levels of index construction, can be into any number of groups.

It can be understood that one or more steps of the methods described herein may be performed using, for example, any of the computer systems 310, 306A, and 314A. Also, in various embodiments of the present invention, market data may be input and stored on, for example, any of the data storage media 306B, 314B and/or on a storage medium or media on the computer system 310A.

The term “computer-readable medium” is defined herein as understood by those skilled in the art. It can be appreciated, for example, that method steps described herein may be performed, in certain embodiments, using instructions stored on a computer-readable medium or media that direct a computer system to perform the method steps. A computer-readable medium can include, for example and without limitation, memory devices such as diskettes, compact discs of both read-only and writeable varieties, digital versatile discs (DVD), optical disk drives, hard disk drives, solid state drivers, ROM (read only memory), RAM (random access memory), PROM (programmable ROM), EEPROM (extended erasable PROM), and other suitable computer-readable media. A computer readable medium can also include memory storage that can be physical, virtual, permanent, temporary, semi-permanent and/or semi-temporary.

### Volatility Index Results and Performance

Results of testing indicate that a volatility-based index framework can provide unexpected advantages over other indexes.

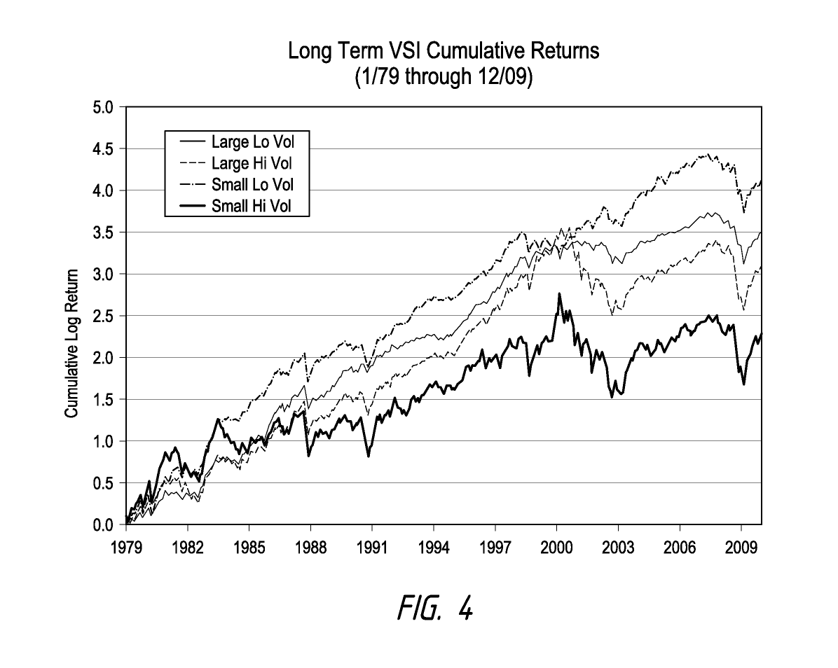

FIG. 4 shows a chart of historical cumulative returns over time for a volatility-based index framework comprising four volatility style indices. These volatility indices correspond to large low volatility, large high volatility, small low volatility, and small high volatility indices. Size (large or small) describes market capitalization—minus closely held shares—of the securities in the index. The four indices are mutually exclusive, and together they represent substantially the entire market.

As time increases, the cumulative returns of the four volatility indices become more distinct and take more definite and stable relative positions. Generally, the small high volatility index has the lowest cumulative returns over time. The large high volatility index tends to have the next highest return over time. The small low volatility index generally has the second highest returns, followed by the small low volatility index which exhibits the best cumulative return performance over time. With few exceptions, this ordering of the indices' cumulative returns appears clearly in the chart.

This ordering, however, indicates a key insight of the present invention which produces beneficial results over other techniques: Rather than a division of cumulative returns along security size (e.g., as would be the case if the two indices with higher cumulative returns were either both of the large or both of the small volatility style indices), the clear division in cumulative returns is between the degrees of volatility. The two indices with the highest cumulative returns were the large low volatility and small low volatility indices. The two indices with the lowest cumulative returns were the large high volatility and small high volatility indices. This indicates that the clearest distinction among index securities, with respect to cumulative returns, is among securities with differing volatilities. Regardless of size, the high volatility securities tend to be associated with lower cumulative returns, and the low volatility securities tend to be associated with higher cumulative returns.

That volatility provides the clearest distinction among cumulative returns is a groundbreaking development that immediately implicates modern portfolio theory: Portfolio theory works best when choices are distinct—when available asset classes or groups are as different as possible. It is this differentiation on which the construction of an optimally efficient portfolio depends. Volatility thus presents a surprising and effective new way to categorize securities for various purposes including determining asset classes, market benchmarking, portfolio construction, portfolio analysis, and fund performance.

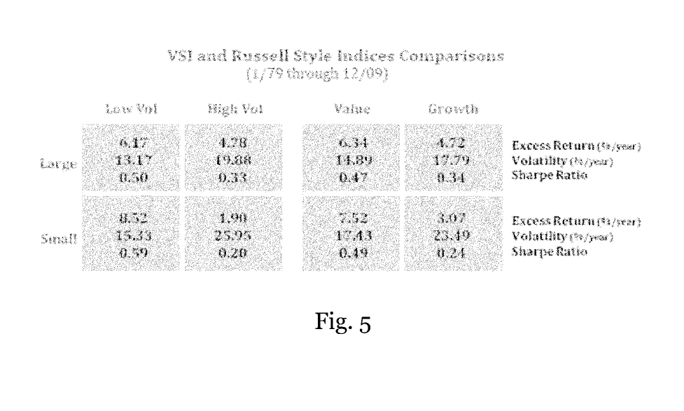

FIG. 5 is a table further illustrating the advantages of a volatility-based index framework. The table shows a comparison between a volatility-based index framework and a growth-value division, as indicated by various metrics calculated using historical data. The volatility-based index framework comprises large low volatility, large high volatility, small low volatility, and small high volatility style indices. The growth-value indices comprise large value, large growth, small value, and small growth indices. For each index, historical data was used to calculate the yearly excess return, volatility, and Sharpe ratio. The Sharpe ratio provides a measure of excess return per unit of risk; it characterizes how well the return of an asset compensates an investor for risk taken.

In the large indices, the difference between the excess returns of the large low volatility style index and the large high volatility style index is 6.71. The difference between the excess returns of the large value and large growth indices is only 2.9, considerably less than the volatility-based index difference. Because differentiation among different classes of securities, especially in returns, is eminently important for asset allocation in portfolio theory, the greater difference in excess returns between the large high volatility and large low volatility indices indicates a better, more distinct division of securities.

Similarly, in the small indices, the difference in the Sharpe ratios of the small low volatility and small high volatility style indices is 10.62. This difference is considerably greater than the difference of 6.06 in the Sharpe indices of the small value and growth indices. Again, these greater differences in the Sharpe ratios of low and high volatility style indices as opposed to growth-value indices illustrate the much more effective differentiation and distinction of market securities provided by a volatility-based index framework.

Volatility style indices provide another great advantage over other indexes: equity volatility has persistence. High volatility securities are much more likely to have high volatility in subsequent periods while low volatility securities are likely to have low volatility; average volatility securities remain generally average. From an investment perspective, persistence translates into ease of prediction for subsequent volatility. This represents a significant improvement over priced denominated metrics (book/price, earnings/price) where price is inherently unpredictable and is frequently characterized by a “random walk” process. Consequently, persistence results in low turnover among the volatility style indices. Thus a security in a low volatility index will tend to remain there when the indexes are recalculated (e.g., on a yearly basis). This is a highly desirable index characteristic as all investors, particularly those that are tax-exposed, benefit from lower levels of transaction costs.

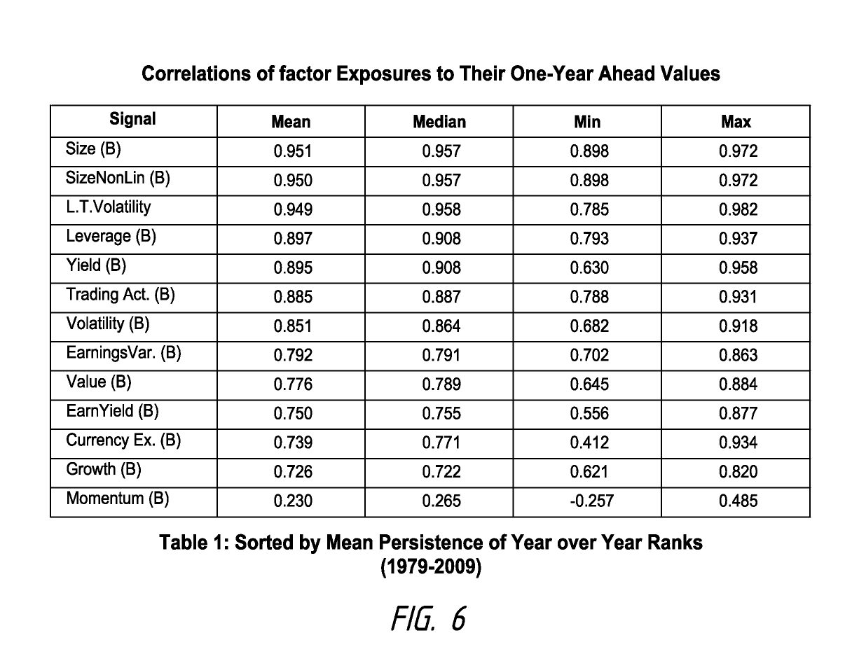

FIG. 6 shows a chart illustrating the persistence of volatility. As can be seen long term volatility maintains sharper distinctions over time than more ephemeral price-denominated measures.

### Volatility Style Indices and Asset Allocation

As discussed, volatility style indices can be used effectively in constructing an optimal portfolio. In modern portfolio theory, the investable market is divided into a number of asset classes. These broad asset classes can be created by dividing the investable market along various dimensions including but not limited to fundamental security type (e.g., stocks, bonds, options, futures, and the like), country or market of origin, or security characteristics (e.g., large-small and value-growth). Each asset class is assigned an expected return and risk level (e.g., as standard deviation or variance), and a covariance matrix is constructed reflecting the correlations among the variances of the various asset classes. Constructing an optimal portfolio is then viewed as a mean-variance optimization problem, whereby an optimal combination of asset classes is found for each level of investor risk tolerance. An optimal combination of asset classes will specify the proportion of the portfolio which should be invested in each asset class. For a given level of expected return, the optimal portfolio will consist of the combination of asset classes that provides the least risk.

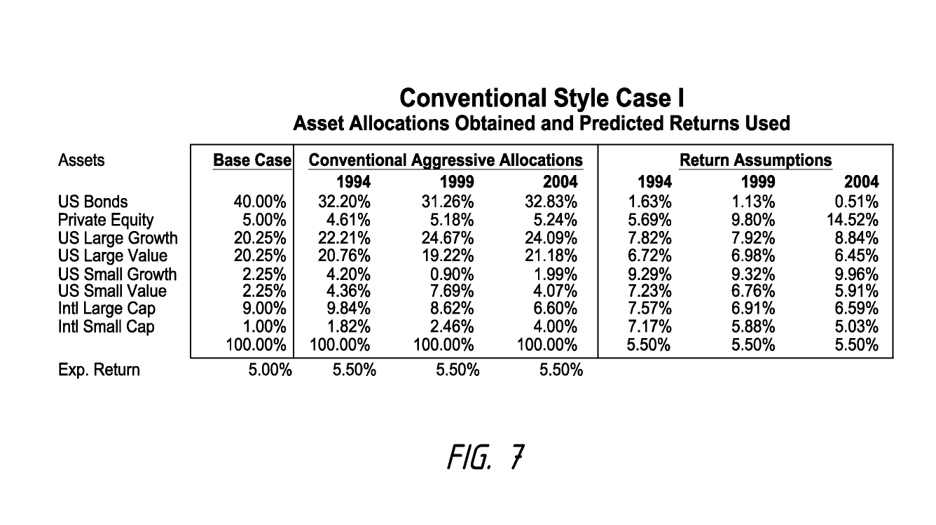

FIG. 7 shows an example of a portfolio constructed from asset classes including U.S. bonds, private equity, U.S. large growth equity, U.S. large value equity, U.S. small growth equity, U.S. small value equity, international large capitalization equity, and international small capitalization equity. As can be seen, the U.S. public equities market has been divided into four sectors, each with its own asset class: large growth, large value, small growth, and small value. Risk, return, and covariance data is determined for each of these asset classes and an optimal portfolio is constructed. Portfolio construction, however, is limited to the listed asset classes. If these asset classes do not represent a meaningful division of investable securities, determining optimal proportions of these asset classes yields a minimally useful result.

Because modern portfolio theory suggests constructing an optimal portfolio by using risk and return data to determine the proportions of various asset classes, portfolio construction works best when asset-type choices are distinct—when available asset classes or groups are as different as possible. The construction of an optimally efficient portfolio depends on this differentiation. As shown, however, volatility style indices, when compared to conventional growth-value divisions, provide greater differentiation in choices for security exposure, not only with regard to risk, but also with regard to other equally important indicators such as cumulative or average return and Sharpe ratio. Thus, volatility style indices can be used in place of alternative market indexes (e.g., growth-value indexes) during portfolio construction to provide more distinct choices in asset classes. Ultimately, this can lead to the construction of a more efficient investment portfolio with more return for any given level of portfolio risk.

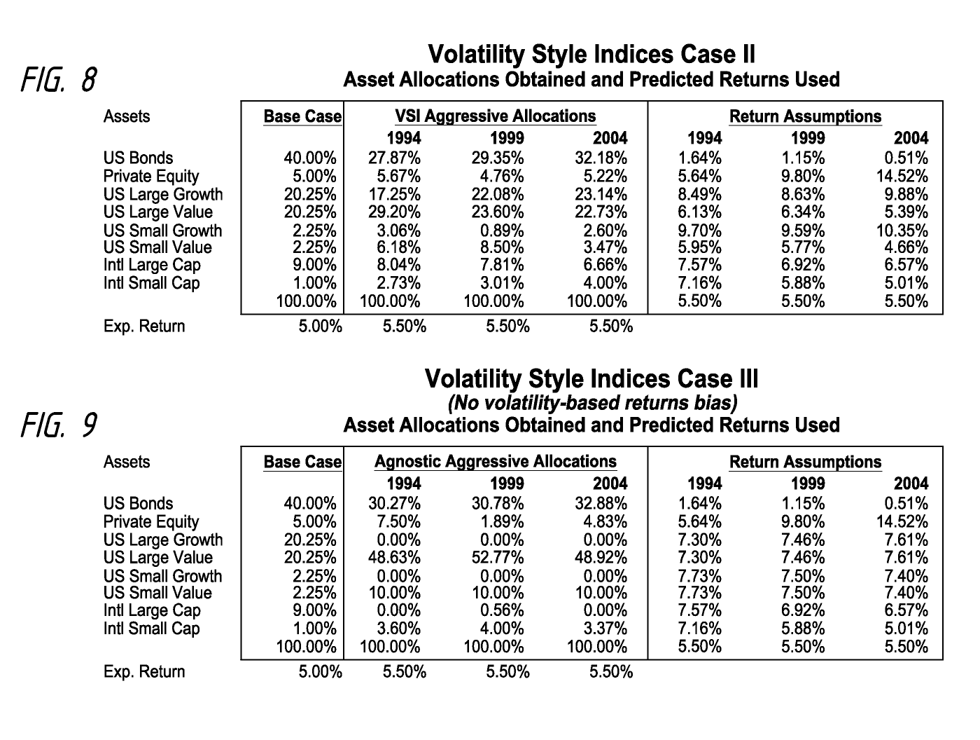

FIG. 8 shows an example of portfolio construction using volatility style indices instead of traditional value-growth indexes. As can be seen, the U.S. public equities market has been divided into four individual sectors, each with its own asset class: large high volatility, large low volatility, small high volatility, and small low volatility. These volatility-based asset classes can be mutually exclusive, and collectively exhaustive. Each of these asset classes, for example, can correspond to one of the volatility style indices in a volatility-based index framework as described herein. Thus, these volatility style indices can substantially represent the public U.S. equities market. Risk, return, and covariance data, provided for example by an index provider, can be determined for each of the asset classes represented by the volatility style indices. With these data, the volatility style indices can, in various embodiments, stand in place of other asset classes traditionally used in portfolio construction to represent the U.S. public equities market (e.g., growth-value indexes). It should be kept in mind that the volatility-based index framework can be applied to any or all securities markets. Thus, the bond market, futures market, options market, and all other markets can be divided into asset classes along the volatility dimension, or along the volatility dimension in combination with another dimension. Further still, the collective market of investable securities can also be divided along the volatility dimension. In any case, division along the volatility dimension can include division into two groups representing, for example, low and high volatility; notably, however, more than two groups can also be used to represent the volatility dimension. For example, in various embodiments, a collection of securities can be divided into three groups (e.g., representing low, normal, and high volatilities) or into 10 groups (representing volatility deciles).

Using the volatility style indices along with the other asset classes, an optimal portfolio can then be constructed. FIG. 8 shows a constructed portfolio's proportion of—and expected return for—each asset class (including the four volatility style indices) for the years 1994, 1999, and 2004. Notably, and in contrast to the conventional portfolio of FIG. 7, the two U.S. large equity indexes are not held in similar proportions; the U.S. large low volatility index consistently makes up significantly more of the portfolio than the U.S. large high volatility index. Also in contrast to the conventional portfolio, the two U.S. small equity indexes are not held in similar proportion; the U.S. small low volatility index consistently makes up significantly more of the portfolio than the U.S. small high volatility index. These differences from the allocation of FIG. 7's conventional portfolio arise from the additional information provided by the volatility style indices. A better, more informed choice of asset classes can thus be made.

FIG. 9 shows another example of portfolio construction using volatility style indices instead of traditional value-growth indexes. In the portfolio of FIG. 9, in contrast to the portfolio of FIG. 8, the volatility style indices do not include an upward correction for the expected returns of high volatility securities. As can be seen, this effectively reduces to zero the portfolio allocations to both high volatility indices (the large high volatility index and the small high volatility index). This occurs because given two asset classes with equal expected returns, modern portfolio theory will prefer the asset class with lower risk.

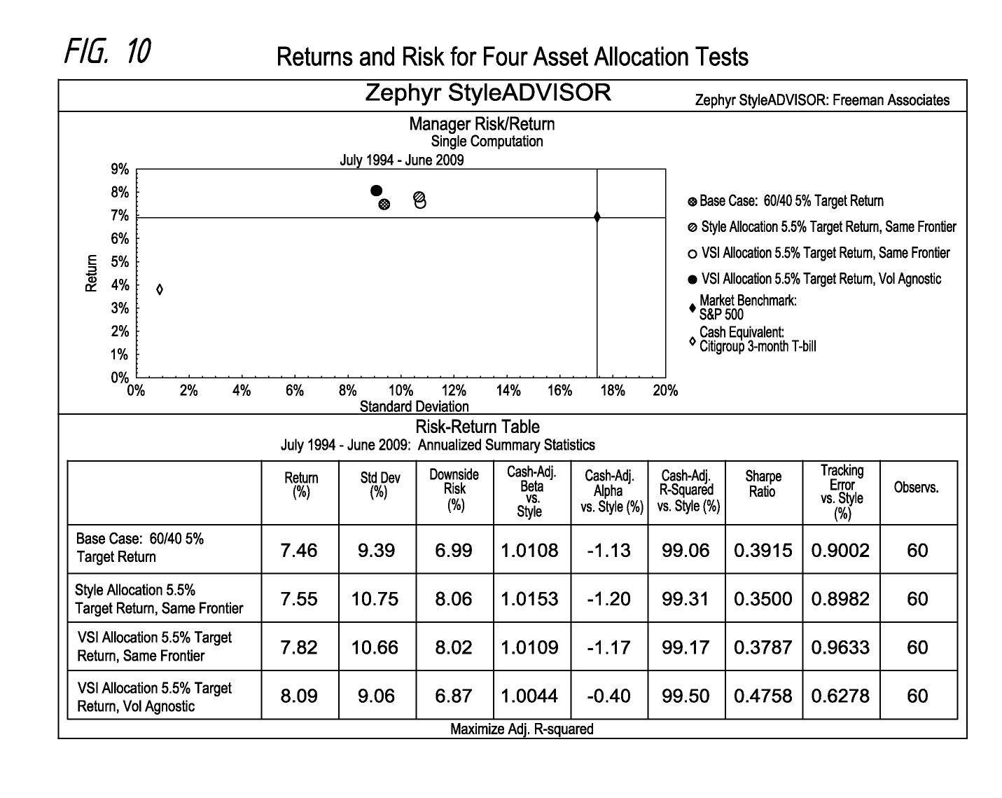

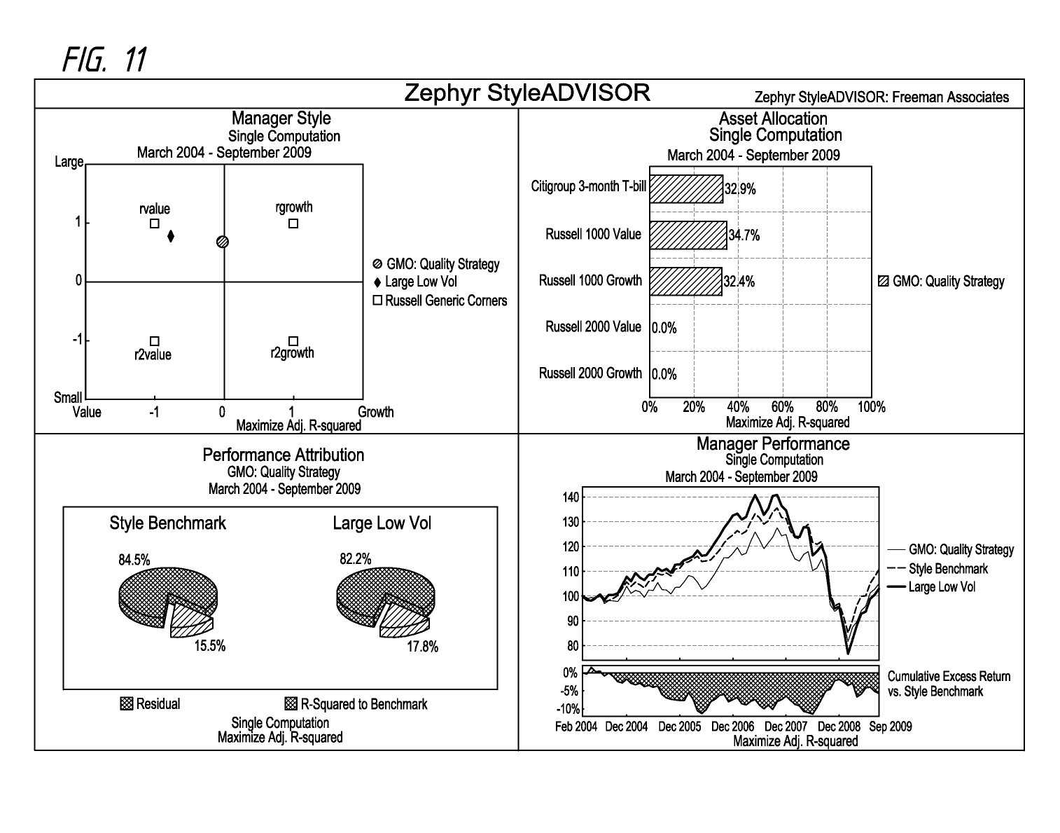

FIG. 10 shows the performance results of two portfolios constructed using volatility style indices compared to the results of two conventional portfolios. A base case portfolio, consisting of 40% bonds and 60% equities, is shown along with a portfolio constructed using standard growth-value style allocation. Also shown are portfolios constructed using volatility style indices. One of the volatility-based portfolios includes an upward bias in expected returns for high volatility securities, while the other volatility-based portfolio does not. As can be seen, the two portfolios constructed using volatility style indices produced the highest returns (7.82% and 8.09%). Furthermore, the volatility-based portfolio not including the upward return bias, while producing the highest return, also produced the lowest volatility and downside risk. Both volatility-based portfolios produced higher returns and lower standard deviations than the standard style portfolio. Because investors desire both higher return and less risk, the volatility-based portfolios outperformed the standard growth-value style portfolio. Further still, the volatility-based portfolio not including the upward return bias yielded the best overall performance, in terms of both risk and return. This clearly illustrates the advantages of a volatility-based index framework.

### Volatility Style Indices in Passive Investment Strategies

Passive investing often involves funds that represent broad swaths of a given market. Financial indices such as those described herein may be used to create an investment fund that substantially replicates the movements of a broad segment of the market, including, for example, the entire market or a portion of the market represented by one of the financial indices. An index fund, also called an index tracker or index tracker fund, may be an “investment” fund, e.g. a mutual fund or exchange-traded fund, designed to replicate a specific index. “Index fund” is a broad term extending across a broad reach of investment funds or collective investment vehicles; the term is to be given its ordinary and customary meaning to a person of ordinary skill in the art and includes, without limitation, open-end funds, closed-end funds, mutual funds, and exchange-traded funds. An index fund may replicate or track a financial index by holding all the securities in the financial index, or by holding securities that represent a statistical market sample of the financial index (which can be accomplished through synthetic indexing or other index-representing or index-enhancing techniques). In synthetic indexing, for example, the securities held by the index fund may be held in proportion to the securities held by the financial index.

Volatility style indices such as those described herein, like other financial indices, may be tracked by an index fund. Tracking may be instituted by purchasing the securities held by the fund or by setting rules for purchasing and selling securities that are substantially similar to the rules or method of constructing the index. A volatility style index fund may be created by retrieving information about a volatility style index constructed according to the method of FIG. 2 herein. Data corresponding to the generated volatility style indices can be retrieved, for example, from the index provider data store 112. The index fund may purchase and sell securities according to the allocation of securities in one or more groups or sub-groups described at step 245 of FIG. 2. A volatility style index fund may be created by following the method of FIG. 2 and purchasing or selling actual securities in one or more groups or sub-groups described at step 245 of FIG. 2. Shares in an index fund may be sold, for example, as mutual fund shares or as securities in an exchange-traded fund.

### Volatility Style Indices in Specialized Holdings

Many investment strategies have unique requirements regarding, among other things, desired risk and return profiles. For example, target-date funds are structured to have an evolving risk-return profile which progressively favors less risky securities as the target date approaches. Thus, over time, asset allocation in these funds shifts to accommodate the evolving target profile. In such strategies, asset classes providing clear choices in risk are particularly important, as it is the changing level of acceptable risk which drives the reallocation of assets. Volatility style indices provide the distinct risk choices necessary to make such reallocation as accurate and as efficient as possible. By providing clear, persistent volatility divisions among various securities, volatility style indices allow an investment manager to more precisely tailor her investment strategy—including asset allocation—for the client's desired target risk-return profile. As discussed above, known indices fail to provide such a clear distinction, resulting in inefficient asset allocation schemes which are not able to target effectively a narrow risk-return profile.

Many other specialized investment scenarios and holdings (for example and without limitation, liability-driven investments, management of insurance capital, nuclear decommissioning trusts, the like, and combinations of the same) have similarly specific risk-return requirements. For the same reasons discussed, volatility style indices provide an efficient and effective way to achieve these specific requirements. Without the distinctive choices in risk provide by a volatility-based index framework, conventional asset classes simply provide insufficient choices to construct portfolios narrowly tailored to target a specific range of risk-return characteristics.

### Plug-and-Play Investment Strategies

As discussed above, a volatility-based index framework can be used effectively in constructing an optimal portfolio by replacing too broad asset classes and inefficiently constructed indexes. Volatility style indices, however, can also be used more generally in existing investment strategies which rely on distinct asset classes created by partitioning investable securities around various dimensions.

Many modern investing strategies rely on partitioning the market of investable securities into various asset classes based on various characteristics, including for example legal distinctions (e.g., between debt, equity, and warrants). Asset class divisions, however, can be created even within a single securities market. Splitting equity markets based on stock market capitalization (e.g., large cap, mid cap, and small cap) is a well-known treatment reflecting the difference in behavior among these equity segments. In traditional growth-value style allocation, for example, the U.S. public equities market is partitioned by market capitalization as well as growth-value measures such as book-to-price ratios or earnings-to-price ratios. Together, the sub-asset classes (which can themselves be referred to and treated as asset classes) created by this growth-value partitioning should represent the whole U.S. public equities market.

Volatility style indices can be used in any modern investing strategy which utilizes distinct asset classes. In such strategies, some or all of the asset classes can be supplanted by volatility style indices. The volatility style indices should together represent the same portion of the market as that collectively represented by the replaced asset classes. For example, in various embodiments, asset classes (which can also be referred to as sub-asset classes) created by dividing a securities market according to growth-value characteristics can be replaced with asset classes created by dividing the securities market according volatility. In general, any number of broader asset classes in an investment strategy can be replaced by taking the union of the asset classes to be replaced, calculating the volatilities for the securities in the union, sorting the securities by volatility, and dividing the sorted securities into volatility-based groups (e.g., groups containing securities with similar or at least contiguous volatilities). The volatility-based groups can then be substituted in the investment strategy for the replaced asset classes. Necessary technical and fundamental measures for the new volatility-based groups can be calculated or inputted into the investment strategy and used to recalibrate the strategy for the asset classes.

In various embodiments, asset classes representing distinct fundamental security types (e.g., stocks, bonds, options, and futures) can be replaced with volatility-based asset classes containing mixtures of the various fundamental types.

### Assessing Portfolio Performance

A volatility-based style index framework can be used effectively in analyzing and evaluating investment manager performance. Investment managers are increasingly committed, at least in part, to zero-beta or alternative beta strategies; while more traditional managers aim for a conventional market-like beta of 1.0 strategy. Volatility style indices can provide insight into the performance of both approaches to investing.

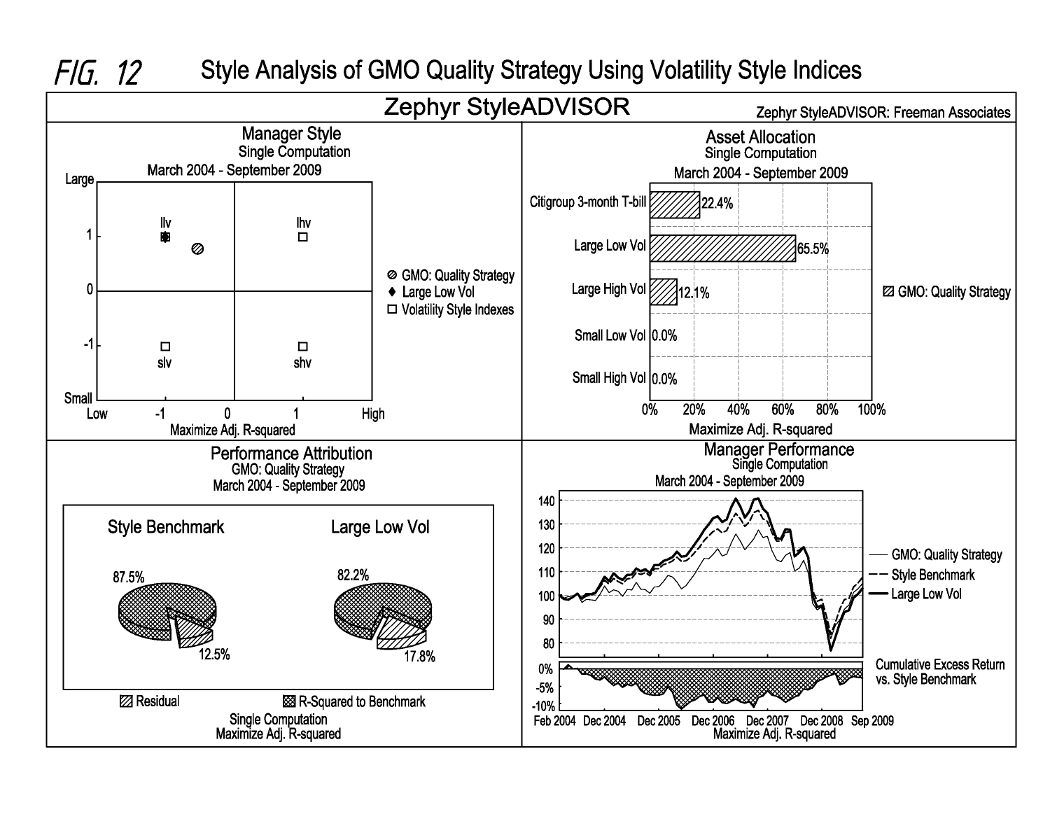

FIGS. 11 and 12 show style analyses of Quality Strategy, an active investment strategy of GMO, an investment management firm. FIG. 11 shows a style analysis of GMO's Quality Strategy using traditional value-growth indexes. As shown in the first chart, the Strategy's style favors large capitalization equities, but is divided equally between value and growth. The second chart shows that the Strategy is described by a relatively even distribution of assets among a risk free asset, large-cap value equities, and large-cap growth equities. Chart 3 shows how well the asset allocation of chart 2 (the style benchmark) describes the returns of the Strategy. R-squared is a statistical measure that represents the percentage of the Strategy's return profile that can be explained by movements in a portfolio corresponding to the asset allocation of chart 2. As shown, the growth-value based asset distribution of chart 2—the style benchmark—describes 84.5% of the Strategy's return profile. Chart 4 shows the strategy's cumulative returns compared to the style benchmark.

FIG. 12, on the other hand, shows a style analysis of the same GMO Quality Strategy using volatility style indices. As shown in the first chart, the Strategy's style, as before, favors large capitalization equities; this time, however, the Strategy clearly favors low volatility equities over their high volatility alternatives. This provides important information about distinct choices made by the Strategy manager not clearly illustrated in the analysis of FIG. 11. The second chart no longer shows an even distribution of assets. Instead, the overwhelming majority of the portfolio is described by the large low volatility style index. Again, this provides more important information about asset allocation decisions made by the fund manager that is not described by the analysis of FIG. 11. Chart 3 shows how well the asset allocation of chart 2 (the style benchmark—this time including the volatility style indices) describes the returns of the Strategy. As shown by the r-squared value of the style benchmark, the asset allocation using volatility-based indices describes 87.5% of the Strategy's return profile. This indicates that the asset allocation using a volatility-based index framework better describes the Strategy's true return profile.

The term “benchmark” used above with respect to FIG. 11 refers to a method of assessing portfolio performance. A benchmark is a standard to which something can be compared. “Benchmarking” is a broad term that may refer creating a standard to which something can be compared; the term is to be given its ordinary and customary meaning to a person of ordinary skill in the art and includes, without limitation, financial indices such as the S&P 500, the Dow Jones Industrial Average, or the Lipper Indexes.

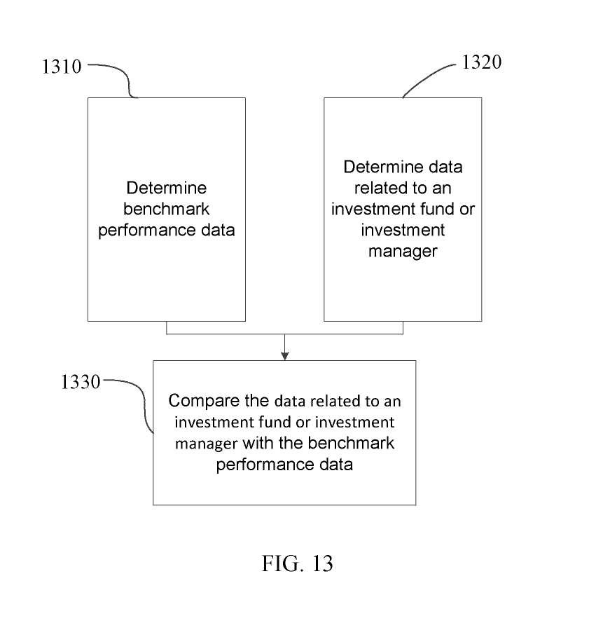

FIG. 13 illustrates an example of a process for benchmarking investment fund or investment managers using an index framework. At step 1310 of FIG. 13, benchmark performance data may be determined. The benchmark performance data may be determined by, for example, by selecting an index. The benchmark performance data may include market data including, for example, information about current and historical price or value, returns, dividends, leverage, yield, trading activity, earnings, growth, momentum, the like, and combinations of the same. At step 1320, data related to an investment fund or an investment manager may be determined. The data related to an investment fund or an investment manager may be related to, for example, an investment fund comprised of securities of a particular asset class or a subset of the entire market. The data related to an investment fund or an investment manager may include market data. The step 1310 may occur before or after the step 1320. If step 1320 is performed before step 1310, the benchmark performance data may be determined at least in part by selecting an index comprised of securities similar to the securities that comprise all of or a portion of the investment fund or investment manager portfolio. At step 1330, the data related to an investment fund or investment manager may be compared with the benchmark performance data.

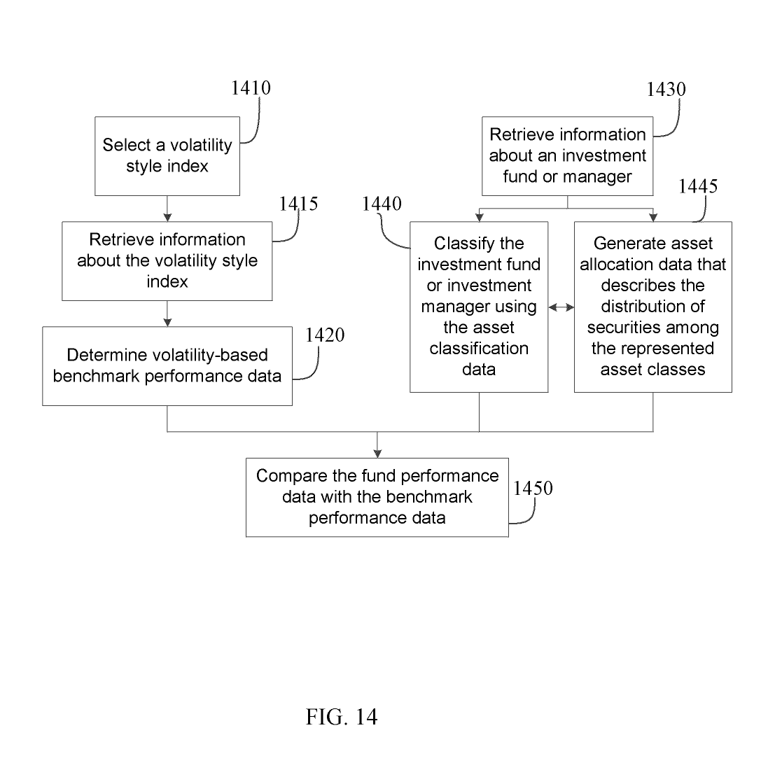

FIG. 14 illustrates an embodiment of a process for benchmarking investment fund or investment managers using a volatility-based index framework. It should be noted that the process of FIG. 14 is only an example of an embodiment, and that alternative embodiments can be provided, for example, by using one or more of the alternatives discussed herein.

The process for benchmarking according to the embodiment of FIG. 14 may begin at step 1410. At step 1410, a volatility style index may be selected. The volatility style index may be an index created according to the process of FIG. 2. The volatility style index may be an index of the entire market or a subset thereof. The volatility style index may also be a sorted securities collect, a group, or a subgroup as discussed herein with reference to FIG. 2. The volatility style index may be, for example, an index representing one or more large-cap, low volatility securities. In some embodiments, the index may be created by the same entity that performs the benchmarking process either before or during the benchmarking process. In some embodiments, the index may be constructed by a different entity than the creator of the benchmark. The constructed index may then be retrieved by the benchmarking entity. At step 1415, information about a volatility style index may be retrieved. The information may be retrieved using a computer system, e.g. the computer system of FIG. 1. The information about a volatility style index may include market data, asset classification data, asset allocation data, and/or volatility-based benchmark performance data. At step 1420, volatility-based benchmark performance data is determined. In various embodiments, determining the volatility-based benchmark performance data may simply require selecting the data to be used for comparison from the information about a volatility style index. In some embodiments, the volatility-based benchmark performance data may be determined by selecting one or more pieces of market data. The selected market data may then be used as the volatility-based benchmark performance data. In some embodiments, the selected market data may be used to calculate the volatility-based benchmark performance data. Such calculations may include, for example, adding one or more prices of securities to represent a market capitalization of an index or all or some portion of an investment fund.

At step 1430, information about an investment fund or investment manager may be retrieved. The information may be retrieved using a computer system, e.g. according to the computer system of FIG. 1. The information about an investment fund manager may include information such as fund performance data for one or more investment funds managed by the investment manager. Fund performance data may include market data about the fund or securities in the fund, for example, information about current and historical price or value, dividends, leverage, yield, trading activity, earnings, growth, momentum, the like, and combinations of the same. In various embodiments, the fund performance data may include total market capitalization of the securities held by the investment fund or funds managed by the investment manager at certain times, such as at regular intervals.

After the information about the investment fund or the investment manager is retrieved, the process may continue by analyzing the information retrieved about the investment fund or the investment manager. This analysis may proceed by at least one of steps 1440 and 1445, and may include both steps, as indicated in FIG. 14. At step 1440, the investment fund or the investment manager may be classified using information retrieved about the investment fund or investment manager. The information used to classify the investment manager or investment fund may be asset classification data. Asset classification data may include market data, including characteristics such as security type, industry type, country, or size (e.g., as measured by market capitalization). In various embodiments, the investment manager or investment fund may be classified based on one characteristic, such as volatility. In other various embodiments, the investment manager or investment fund may be classified based on more than one characteristic, such as a large-cap, low volatility fund classification or a small-cap, high growth, high volatility fund classification. At step 1445, asset allocation data may be generated that describes the distribution of securities among the classifications represented in the asset classification data. For example, asset allocation data may include market data, including characteristics such as security type, industry type, country, or size (e.g., as measured by market capitalization). Asset allocation data may include the same or substantially similar information as asset classification data. In various embodiments, the asset allocation data may describe all the securities held by one or more investment funds based on one or more characteristics, such as capitalization or volatility. In other various embodiments, the asset allocation data may be describe one or more collection of securities that represents a subset of all the securities held by one or more investment funds based on one or more characteristics, such as a large-cap, low volatility subset. After either or both steps 1420 and 1445, the process may continue.

At step 1450, the fund performance data (which may include the classification of the investment fund or investment manager), the asset classification data, the asset class distribution, or the asset allocation data, may be compared with the volatility-based benchmark performance data. This comparison may be made using calculations, such as an r-squared calculation, between the investment fund or investment manager performance and the volatility-based benchmark performance data, such as the volatility index performance. The calculation may be made using alternative measures. In further various embodiments, the comparison may be made using tabled or graphical representations, and the steps described above can be accomplished in different sequences.

As can be seen from the preceding analyses, a volatility-based index framework can provide a more effective and more descriptive way of analyzing and evaluating a manager's performance. In addition to providing insights into a manager's investment philosophies and strategies, effective style analysis can be used to determine whether a manager has skill, and therefore whether her active management fees are worth paying. In order to properly gauge such performance, a proper benchmark for the manager is required. By providing an asset portfolio that more closely mirrors the active manager's strategy (e.g., constructed using style analysis as shown above), volatility style indices can provide such a benchmark. The performance of the manager can then be compared to the volatility-based benchmark. A manager who outperforms her benchmark in terms of risk or return can be given a positive evaluation, and investment in the manager's fund can be increased. A manager who sometimes or consistently underperforms her benchmark in terms of risk or return can be given a negative evaluation, and investment in the manager's fund can be decreased.

### Additional Embodiments of a Volatility-Based Index Framework

It should be understood that various embodiments of the techniques and methods described herein may be used, for example and without limitation, to create and publish an index, to license a portfolio of assets corresponding to an index, to offer a security that is linked to an index that is created using the techniques and methods described herein, to offer an exchange traded fund (ETF), mutual fund, unit investment trust, or the like that replicates the performance of an index that is created using the techniques and methods described herein, and to develop an investment strategy based on an index that is created using the techniques and methods described herein or to create and manage a portfolio.

### Measures for Constructing a Volatility-Based Securities Index Framework

Securities indices may use certain measures of market data as input when constructing the index framework. For example, a value index may use book-to-price ratio measure as an input in constructing an index, or a growth index may use a long-term growth forecast measure as an input in constructing an index. Securities indices may preferably use more than one measure as an input in constructing an index. In construction of a volatility-based securities index, individual stock information (e.g., market data including current and historical pricing data, outstanding shares, dividends, leverage, yield, trading activity, earnings, yield, etc.) on prior volatility may be used. Measures used as input in constructing a volatility-based securities index can incorporate total return information (e.g., price changes plus dividend payout). Each measure may be retrieved, calculated, or otherwise determined using one or more of a number of different methods. For example, a volatility measure may be calculated using a standard deviation, a variance, interquartile range, or any other measure of statistical dispersion across a data set. Each measure may further include data from over a number of different lengths of time or at different intervals. For example, a volatility measure may be calculated by determining the standard deviation of a volatility measure from five or more years in the past, for example, using monthly observations. Shorter-term calculations of volatility measures over less than two years may use weekly or daily performance histories. As discussed above, volatility measures can have the statistical property of persistence meaning that low volatility stocks in one period can be more likely to have sustained low volatility in the next period. Likewise, high volatility stocks can be more likely to sustain their high volatility. Persistence characteristics can provide a rich taxonomy to classify stocks and subsequently construct volatility-based securities indices.

Construction of volatility-based securities indices may benefit from inclusion of robust fundamental information on each constituent security. However, even some of the most widely used fundamental measures for investment analysis may not be equally useful in the construction of indices of every type of style. For example, construction of a growth index may not benefit from inclusion of market capitalization data, but may benefit from inclusion of measures like growth forecasts and price ratios. In the construction of a volatility-based securities index, some widely used fundamental measures may be less useful and other fundamental measures may be more useful.

Many fundamental measures for investment analysis may be computed using a price ratio, which may be further described as a measure of market capitalization. For example, many fundamental measures in investment analysis are computed using a price ratio and may be treated as Price/Fundamental ratio. (In practice, however, the inverse of the Price/Fundamental ratio may be used to facilitate computations.) Further, since stock prices can be inherently unstable, price denominated measures may change rapidly even in the absence of new fundamental information, e.g. data that may be reasonably expected to impact the price or value of a security. Due to inherent instability that may exist independently of fundamental information, price measures calculated as volatility measures may be less useful as an input in the construction of a volatility-based securities index. In a further example, forecasted earnings and forecasted earnings growth may be used as a fundamental measure in investment analysis. Forecasted earnings and forecasted earnings growth, along with some other forecasted measures, may depend heavily on the analyst, method of analysis, input data for the analysis, and other factors. Forecasted earnings and forecasted earnings growth, whether forecast over a short-term future period or a long-term future period, may contain little fundamental information and may introduce random change into measures used as input into a volatility-based securities index.

Some examples of fundamental measures in investment analysis that may be less useful as inputs in construction of a volatility-based securities index may include:
Price/Earnings (historical);
Earnings (historical)/price;
Price/Earnings (forecast);
Earnings (forecast)/price;
Price/Book Value;
Book/Price;
Price/Dividend Payout;
Dividend Yield;
Price/Sales;
Sales/Price; and
Earnings Growth (forecast).

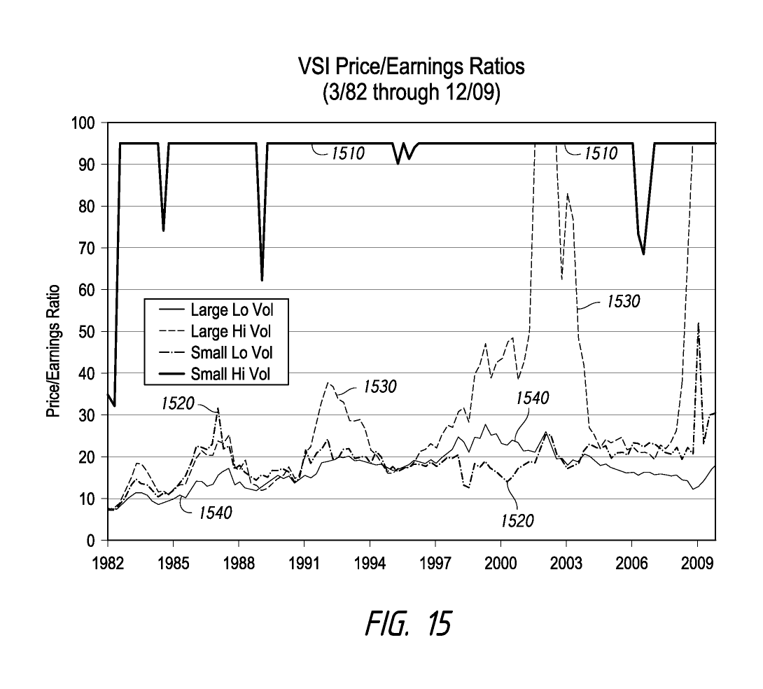

FIGS. 15-19 show charts of some of the fundamental measures listed above. Each chart shows a volatility-based index framework comprising four volatility style indices. These volatility indices correspond to large low volatility 1540, large high volatility 1530, small low volatility 1520, and small high volatility 1510 indices. Size (large or small) describes market capitalization minus closely held shares of the securities in the index. The four indices are mutually exclusive, and together they represent substantially the entire market.

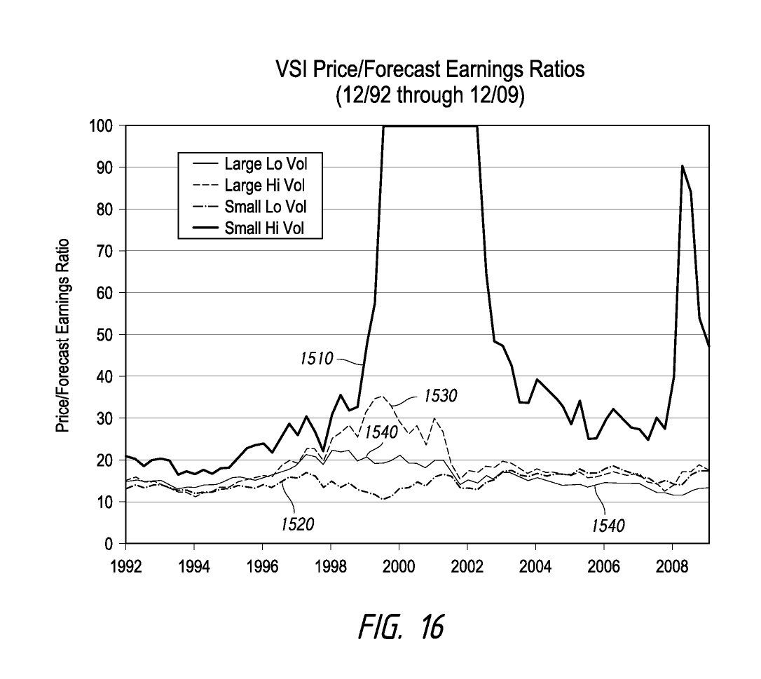

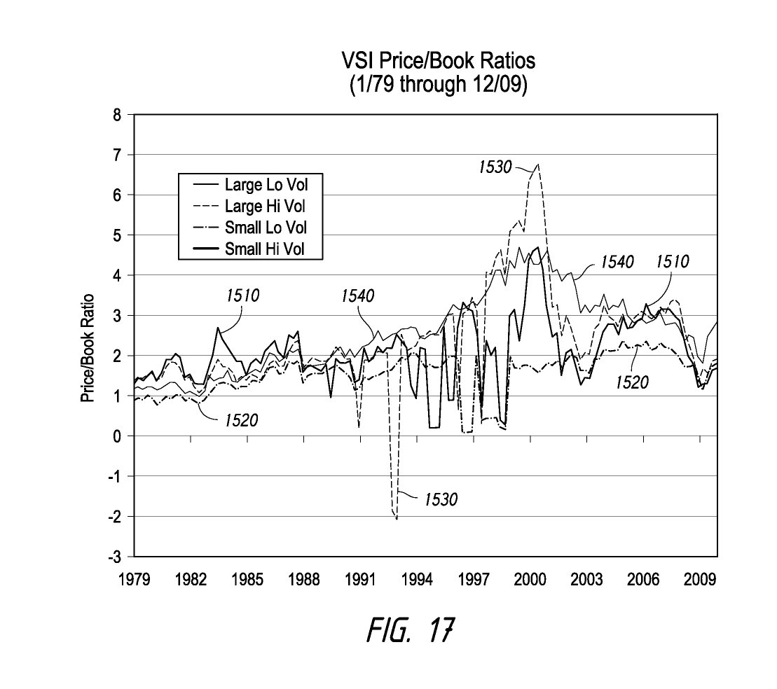

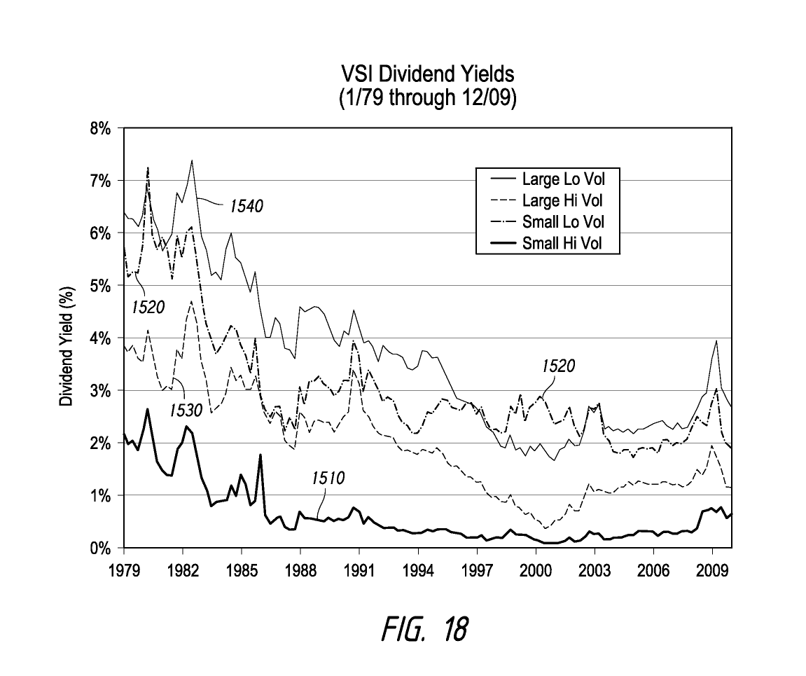

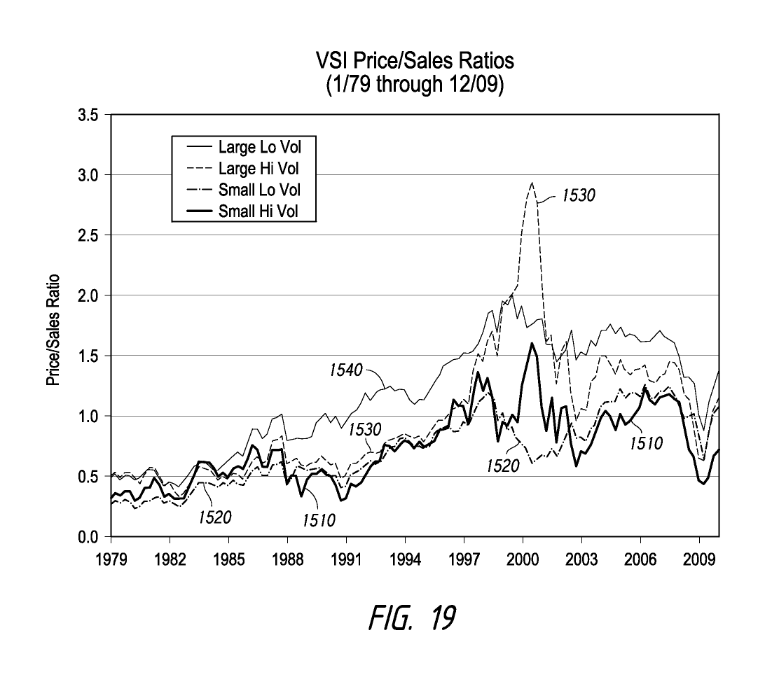

FIG. 15 shows a chart of price/earnings ratios for a volatility-based index framework comprising four volatility style indices. FIG. 16 shows a chart of price/forecast earnings ratios for a volatility-based index framework comprising four volatility style indices. FIG. 17 shows a chart of price/book ratios for a volatility-based index framework comprising four volatility style indices. The variations in price to book ratio over time may provide support for the statement that price to book ratios provide less fundamental information as to value. FIG. 18 shows a chart of dividend yields for a volatility-based index framework comprising four volatility style indices. FIG. 19 shows a chart of price/sales ratios for a volatility-based index framework comprising four volatility style indices. FIGS. 15-19 may support the assertion that certain inputs, including Price/Earnings (historical); Price/Earnings (forecast); Price/Book Value; Dividend Yield; and Price/Sales may vary in volatility more significantly over time than other input variables, resulting in a reduced statistical property of persistence. Reduced persistence may reflect higher dependence on outside factors, for example, the method of analysis, and lower dependence on the fundamental value of the security.

Further measures may also be less useful as inputs for a volatility-based securities index. One premise of the construction of a volatility-based index, among others, may be that the relationship between risk and return across the market is demonstrably broken. Under this assumption, use of certain measures of risk, including measures of either market risk (e.g. systematic risk) or specific risk (e.g. residual risk) or both may constitute using data that, under the premise, is also demonstrably broken. Some examples of risk measures that depend on market or specific risk that may be less useful as inputs in construction of a volatility-based securities index may include:
Beta;
Alpha; and
Residual volatility.

In the construction of a volatility-based securities index, some fundamental measures may be more useful. Many variables (e.g., fundamental measures) may be well suited to augmenting volatility classifications. For example, fundamental measures dependent on fundamental information may be more likely to fluctuate due to data that can reasonable impact the value of a security. Further, measures or inputs that may not be denominated by price or market value may be more useful in the construction of a volatility-based securities index. Some examples of fundamental measures in investment analysis that may be more useful as inputs in construction of a volatility-based securities index may include:
Management Effectiveness;
Return on Equity;
Return on Assets;
Net Share Repurchase Activity;
Leverage, which may include indicators such as Debt/Assets, Debt/Equity, Interest Coverage, or Debt Rating/Default Risk; and
Earnings Success, which may include indicators such as Historical Earnings Growth Rate and Earnings Variability.

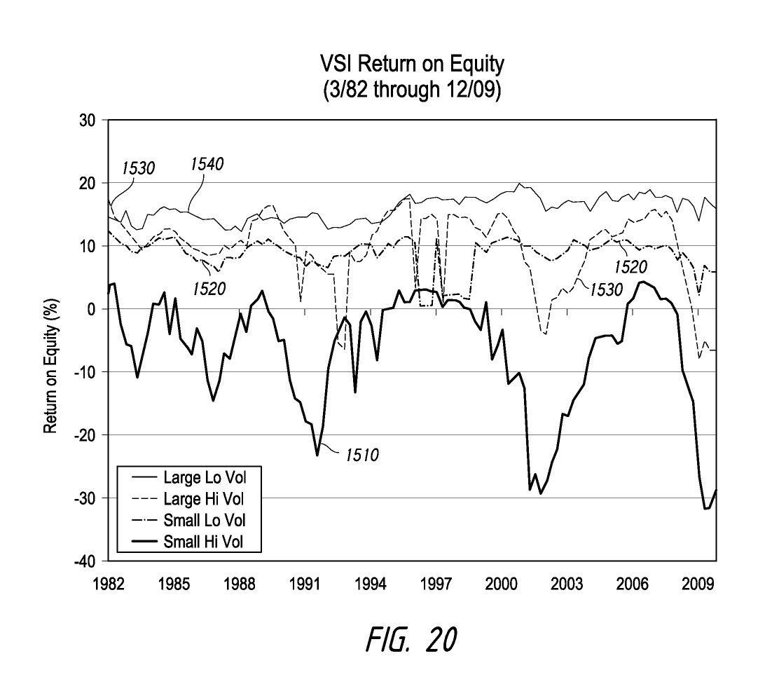

FIG. 20 shows a chart of return on equity for a volatility-based index framework comprising four volatility style indices. The chart of FIG. 19 shows a volatility-based index framework comprising four volatility style indices. These volatility indices correspond to large low volatility 1540, large high volatility 1530, small low volatility 1520, and small high volatility 1510 indices. The four indices are mutually exclusive, and together they represent substantially the entire market. According to the chart, the large low volatility input remains stable over time. The other input vary more than the large low volatility input over time, with the most significant first and second order variations occurring in the small high volatility input. This chart may provide support for the statement that certain inputs, including return on equity, may provide higher quality fundamental information for a volatility analysis.

### Weighting Scheme for Measures of Constructing a Volatility-Based Securities Index Framework

Any number of variables may be used as inputs in the construction of a volatility-based securities index framework. The simplicity or complexity of the VSI weighting scheme will be a function of the number of variables used and the number of indices to be created. Objective or subjective weightings of the variables may be used to create an aggregate score upon which the stocks can be partitioned as shown in the method of FIG. 2, e.g. into groups according to low and high volatility, or into subgroups according to multiple dimensions such as market capitalization and volatility. Assignment to respective volatility-based groups on the indices can be facilitated using statistical models (e.g. linear or non-linear regression models, Probit Analysis, etc.) or employing Bayesian models which impose asubjective limitations on factors. The advantage of rules-based assignment models allows for a more objective framework upon which to create historical simulations of the indices.

In a simple implementation, a single measure of volatility/stability can be used to create two indices each containing identical amounts of market capitalization or free float. For example, a volatility-based securities index may be constructed by retrieving information relating to a set of securities, potentially including one or more type of market data, and calculating a variance of a single variable, for example, earnings, over a historical five year period on a monthly basis. The set of securities may then be listed, grouped, or sorted, or even just provided with, the volatility calculation. In this implementation, a simple ordinal ranking may suffice to create a useful volatility-based index.

In a slightly more complex implementation, multiple variables or factors may be used. An objective rule-based weighting analysis may be established. For example, for each security, construction of the volatility-based securities index may require calculating a standard deviation of a single variable such as price over a five year period using monthly intervals and calculating a standard of a single variable such as earnings over a five year period. Each calculated measure, in this implementation, price volatility and earnings variability, may be weighted. The weighting may be achieved by first normalizing the calculated measures and second averaging the normalized measures. The set of securities may then be listed, grouped, or sorted, or even just provided with, the volatility calculation.

Even more complex implementations may be used, potentially even including factors that are more or less useful to the volatility analysis. Other methods of weighting, normalization, and calculation may further be used. It should be understood that various embodiments and implementation of the techniques and methods described herein may be used, for example and without limitation, for any of the uses listed herein. Those of ordinary skill in the art will recognize, however, that these and other elements may be desirable for practice of various aspects of the present embodiments and implementations.

What is claimed is:

1. A method comprising:
retrieving, by a computer system comprising computer hardware, information about an investment manager, the information about an investment fund manager including fund performance data;
selecting a volatility style index;
retrieving information about the volatility style index, the information about a volatility style index including asset classification data and volatility-based benchmark performance data;
analyzing the investment manager by at least one of classifying the investment manager using the asset classification data and generating asset allocation data that describes the distribution of securities among the asset classes represented in the asset classification data; and
comparing the fund performance data with the benchmark performance data.
